(19) United States
(12) Patent Application Publication
(10) Pub. No.: US 2009/0070240 A1
(43) Pub. Date: Mar. 12, 2009

(54) Method and system to us either or both a centralized function in order to facilitate property use arrangements, and/or to use life insurance policy death benefits as balance sheet assets. These may or may not encourage loan default and foreclosure avoidance

(76) Inventor: Richard M. Millar, Olympia, WA (US)

Correspondence Address: Richard M. Millar, P.O. Box 395, Olympia, WA, 98507, US

(21) Appl. No.: 11/899,753

(22) Filed: Sep. 7, 2007

(51) Int. Cl. G06Q 40/00

(52) U.S. Cl. 705/30; 705/35; 705/39

(57) ABSTRACT

Supporting the homebuyer's ability to remain in their property, in lieu of default and foreclosure, this method and system is useful in order to create a temporary solution to the rising problem of loan defaults. This method and system may be used for any loan. Instead of a lender processing a judicial or non-judicial foreclosure, and thereby absorbing large debits on their balance sheet, a lender may use this method and system in order to maintain an offsetting balance sheet asset until a new loan is issued. This method and system may be employed for as long as the lender and borrower wish, i.e. as long as the workout takes.

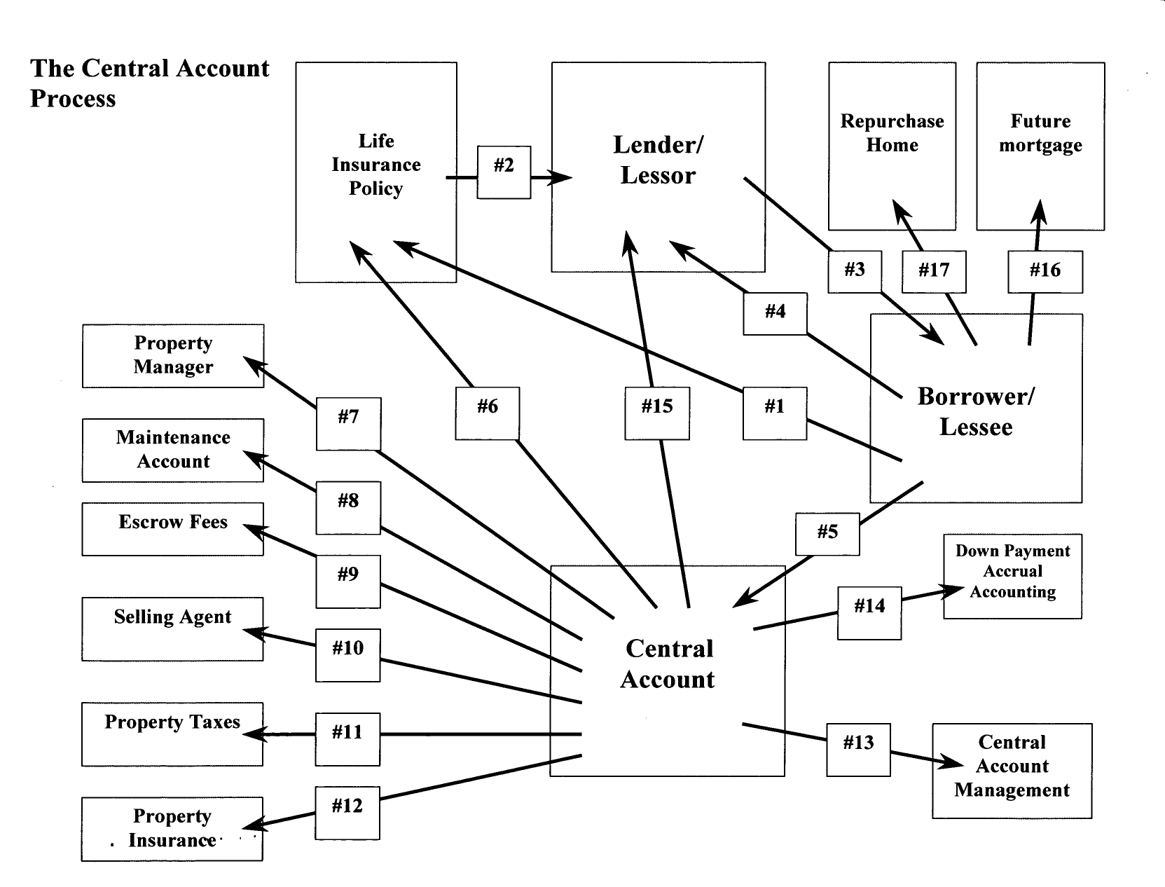

The lender and borrower secure for a life insurance policy, on the borrower's life. The death benefit equals a proportion of the amount of the defaulting loan or the difference between the property value and the loan amount. There is insurable interest. The policy may be owned by the Lender/Lessor or the Borrower/Lessee (previous borrower).

The Lender and Borrower negotiate a lease-option on the property. Once the insurance policy and lease-option are secured, the borrower may quit claim the property to the lender. The lease-option gives the borrower the right to repurchase the property. The borrower pays the costs listed below (1-9), as parts of the monthly lease payment. Payments go to a central account. The central account uses the gross rents to then:
1. Pay escrow costs, if any.
2. Pay property management costs, if any.
3. Pay central account management fees.
4. Pay life insurance premiums or accruals.
5. Pay referring agent a referral fee for ongoing work, if any.
6. Pay property maintenance accruals.
7. Pay property insurance premiums or accruals.
8. Pay property taxes or accruals.
9. Pay other costs as needed.
10. Pay remaining monies to the Lessor.

### CROSS-REFERENCE TO RELATED APPLICATIONS

None.

### STATEMENT REGARDING FEDERALLY SPONSORED RESEARCH OR DEVELOPMENT

No part of this invention was derived with Federally sponsored research or development.

### REFERENCE TO SEQUENCE LISTING, A TABLE, OR A COMPUTER PROGRAM LISTING COMPACT DISC APPENDIX

The Drawing describing this invention is attached herewith and described in the Description of Drawing below.

### BACKGROUND OF THE INVENTION

Millions of property owners are at risk of, or actually are, defaulting on their loans and/or mortgages. Foreclosed loans and loss of homes are detrimental to individuals, families, lenders and society.

### BRIEF SUMMARY OF THE INVENTION

This method and system may or may not be used in order to create a temporary solution to the rising problem of loan defaults and mortgage foreclosures. Instead of the lender processing a judicial or non-judicial foreclosure and thereby absorbing large debits on their balance sheet, the lender uses this method and system in order to maintain an offsetting balance sheet asset, until a new loan is issued on the property. A centralized account may or may not be used to manage the payments.

### DESCRIPTION OF THE DRAWING

1. Step #1—The borrower applies for and secures a life insurance policy on his/her life. The borrower is the insured. Either the borrower or the lender is the owner. The lender is the payor.
   A. Death Benefit—The amount of death benefit, applied for, can either be for the amount of the outstanding loan or a percentage of the difference between the outstanding loan amount and the value of the property. Since property values may decline further, the death benefit may be higher than the difference between the outstanding loan amount and the value of the property, e.g. 200%-300%. The death benefit may or may not be decreased and/or increased from time to time in order to accommodate the changing value of the property.
   B. Insurance Policy Type—Any type of insurance policy may be used. The optimal policy may or may not be a 20-year level term. The policy may or may not include waiver of premium and/or conversion benefits.
   C. Insured—The borrower is the insured.
   D. Lender as Owner—The Lender may or may not be the policy owner.
   E. Borrower as Owner—The Borrower may or may not be the policy owner. If the Borrower is the owner, the Borrower irrevocably agrees to make no policy changes without the Lender's written agreement.
   F. Beneficiary—If the Lender is the Owner, the Lender is the irrevocable beneficiary, to the extent of the indebtedness. The Borrower may name the beneficiary for any remaining death benefits.
      If the Borrower is the Owner, the Lender is the irrevocable beneficiary, to the extent of the indebtedness. This right/designation is secured with an irrevocable Collateral Assignment on the policy.
   G. Payor—The Lender is the payor, through the method and system process.
2. Step #2—The Lender is the beneficiary, to the extent of the indebtedness or a proportion of the indebtedness. The Lender may or may not use the life insurance policy's death benefit, a proportion of the death benefit, the present value of the policy's death benefit or a proportion of the present value of the policy's death benefit, as an asset and/or credit on their balance sheet.
3. Step #3—The Lender and Borrower agree to a sign a Lease-Option Agreement. This agreement may or may not be five-year (this is a variable) lease-option, on the property. The lease-option may or may not be renewed up to five times.
   The Borrower will pay monthly lease payments. These lease payments may or may not be equivalent to the greater of his/her old, monthly mortgage, or the prevailing/inflating market rent, for the duration of each lease. Each monthly lease payment may be negotiated to be:
   A. Level, i.e. not increasing, for the duration of each lease, or
   B. May or may not be reset at every lease renewal, or
   C. May or may not be reset annually.
   D. There may or may not be time restrictions or limitations on the use of the method and system or any similar method/technique/strategy.
   The monthly lease payment reset may or may not be based upon a pre-agreed index, e.g. The National CPI-U every January 1. This index may or may not be incorporated into each lease-option.
4. Step #4—Once the Lease-Option is signed, the Borrower will transfer property ownership to the Lender. The Borrower becomes the Tenant and Lessee. The Lender becomes the Landlord and Lessor.
5. Step #5—The Lessee pays the lease-option payment to the central account. This monthly payment may or may not be via ACH transfer, or ACH-like transfer.
6. Step #6—The central account may or may not use lease payments to pay life insurance premiums. Life insurance premiums may be accrued monthly and paid annually, at the central account's discretion.
7. Step #7—The central account may or may not use lease payments to contract with, supervise and compensate property management as needed.
8. Step #8—The central account may or may not use monthly lease payments to accrue a percentage of the monthly lease-option payment for routine property maintenance. Accruals may or may not stop when this account equals no more than a certain percentage of the then value of the property. For this purpose, the value of the property may or may not be assessed at the beginning of each lease-option period. Maintenance accruals may or may not restart any time that the maintenance account holds less than a percentage of the then value of the property. Interest on this accrual account will be credited to the maintenance account.
9. Step #9—The central account may or may not use lease payments to employ, supervise and compensate escrow services as needed.
10. Step #10—The central account may or may not use lease payments to compensate referring agents as needed.
11. Step #11—The central account may or may not use lease payments to pay property taxes. Taxes may be accrued monthly and paid semi-annually or annually, at the central account's discretion.
12. Step #12—The central account may or may not use lease payments to pay property insurance. Property insurance may be accrued monthly and paid semi-annually or annually, at the central account's discretion. The property owner may or may not determine the coverage and cost of the property insurance. The property owner may or may not secure the property insurance.
13. Step #13—The central account may or may not use lease monthly payments to compensate the Inventor, i.e. the owner of the central account, for management services.
14. Step #14—The central account may or may not use monthly lease payment values to calculate and accumulate a growing down-payment accounting entry. The Lessee may use this accounting value, as part of his/her down payment, when he/she repurchases the property. This monthly accounting entry accrual may or may not be incorporated into each lease-option. For example, 25% of each lease payment will be credited to the Lessee when he/she repurchases the property. The formal declaration to repurchase the property must be made during the term of the lease-option.
   If the lease-option expires, the accounting accrual may or may not be forfeited.
15. Step #15—The central account may or may not use remaining lease payments to pay the Lessor/Landlord monthly.
16. Step #16—At any time (during the term of each lease-option) that the appraised value of the property, plus the down-payment accounting entry, equals at least a pre-agreed upon percentage of the old loan amount, plus the stated loan growth index, e.g. at 20%, the Lessee must secure a new mortgage and re-purchase the property from the Lessor. The repurchase price may or may not be set by the terms of the lease-option agreement.
   The repurchase price may or may not be based on a new appraisal. The terms of the repurchase may or may not be established by the lease-option agreement. The stated loan growth index, which may or may not be used to appreciate the value of the old remaining loan balance, applied at the start of each lease-option, may or may not be incorporated into each lease-option. The stated growth loan index may or may not be applied annually. Alternatively, the stated loan growth index may or may not be applied at the beginning of each lease-option renewal time.
17. Step #17 The Lessee may or may not repurchase the property from the Lessor at the then appraised value.

### DETAILED DESCRIPTION OF THE INVENTION

The description of the invention is detailed in the above section, which details the invention drawing.

### DRAWING

The drawing of the invention is enclosed herewith.

1. Any type of for-profit or not-for-profit legal entity may or may not decide to use a life insurance policy's death benefit, or the present value of the death benefit, as an asset or credit. This asset and/or credit may or may not be used on their balance sheet, or otherwise in their accounting, to help offset an outstanding indebtedness or debit. Interest due on this debt, if any, may or may not be forgiven annually by the lender.

2. Any business, which lends money, may or may not decide to use this method and system, or a similar method/technique/strategy to:
A. Help, facilitate, delay, forestall, avoid and/or eliminate a judicial or non-judicial default procedure and/or foreclosure on indebted property.
B. Provide assistance to distressed property owners.
C. Provide for the betterment of society and the economy.

3. The method and system, or any similar method/technique/strategy, may or may not use a central or centralized account to receive all types of required or non-required payments. This account may or may not then disburse payments.
This account may or may not use automatic, electronic or similar methods of receiving and/or disbursing payments. These transfers are not intended to be limited, in any way, to only within the United States, Canada and/or Mexico. All nations and/or national unions, e.g. the European Union, the North American Union (when established) or their successor(s), may or may not also be included by the scope and reach of this invention.
The centralized account may or may not be established to hold/retain shorter frequency payments, in order to accrue for longer period and/or less frequent payments. An example is, but is not limited to, accruing monthly payments in order to pay annual disbursements.
